(19) United States
(12) Patent Application Publication
(10) Pub. No.: US 2005/0240483 A1
(43) Pub. Date: Oct. 27, 2005

(54) Document managing system and method

(76) Inventors: Shinobu Ito, Kawasaki (JP); Mamoru Ozaki, Sagamihara (JP); Mashiho Kawamura, Kawasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/063,575

(22) Filed: Feb. 24, 2005

(30) Foreign Application Priority Data
Apr. 26, 2004 (JP) 2004-129510

(51) Int. Cl. G06F 7/00

(52) U.S. Cl. 705/24

(57) ABSTRACT

A document managing system includes a document receiving section for receiving document, a document item database for storing a correspondence between the document data and bill of lading (B/L) data, a B/L creating section for creating B/L data according to the document data and the document item database. The document managing system also includes a letter of credit (L/C) storage for storing L/C data, a document storage for storing the document data and the B/L data, a document data collation database for storing a correspondence between the L/C data and the document data, a negotiation request receiving section for receiving negotiation request data for a document bill to which an identifier of the document data is set, and a document collating section for collating, according to the document collation database, the document data indicated by an identifier set to the negotiation request data with the L/C data.

### INCORPORATION BY REFERENCE

The present application claims priority from Japanese application JP 2004-129510 filed on Apr. 26, 2004, the content of which is hereby incorporated by reference into this application.

### BACKGROUND OF THE INVENTION

The present invention relates to a document managing system for and a document managing method of managing documents of foreign trade business including import and export business. The documents include electronic documents, and the foreign trade business also includes domestic trade business.

In export business, various kinds of documents are exchanged between parties concerned. FIG. 24 is a schematic flow diagram showing a general flow to export goods by sea.

First, an export trader or an exporter makes a contract for trade with an import trader or an importer. The importer requests a financial institution at an import location (to be referred to as an import location financial institution hereinbelow) to issue or to open a letter of credit (L/C). According to the L/C, the financial institution guarantees payment for the goods.

When the L/C is received from a financial institution at an export location (to be referred to as an export location financial institution hereinbelow), the exporter creates trade documents such as an Invoice (I/V) and a Shipping Instruction (S/I). The exporter sends or passes the documents to a carrier to instruct loading or shipment of goods. The carrier confirms receipt or loading of goods according to the received documents and creates a Bill of Lading (B/L) which is a form of securities required for the importer to receive the goods at a port of landing.

Thereafter, the exporter brings the trade documents including the bill of lading to the export location financial institution to draw or issue a document bill. The importer can receive the trade documents including the bill of lading by paying the amount of money indicated by the document bill.

Additionally, at issuance of the document bill, the exporter submits to the export location financial institution a set of the trade documents including the bill of lading together with a bill negotiation request form. The financial institution collates items described on the letter of credit with items described on the trade documents. When the collation results in satisfaction of a predetermined condition, the financial institution negotiates the document bill. As a result, the exporter can collect the amount of money for the goods.

### SUMMARY OF THE INVENTION

The process of B/L creation is jobs to combine and to transcribe items described in trade documents such as an invoice (I/V) and a shipping instruction (S/I) and hence requires a large number of job steps.

Additionally, in the negotiation of a document bill or documentary draft in the export location financial institution, the trade document are visually collated with the letter of credit. Therefore, trade documents are often returned to the exporter because of discrepancy therebetween. This disadvantageously increases the number of jobs before the document bill is negotiated.

It is therefore an object of the present invention to provide a document managing system and a document managing method in which a bill of lading is created and trade documents are collated with a letter of credit.

To achieve the object according to the present invention, various kinds of document data are received from a client device to create data of a bill of lading according to the received data. According to the present invention, the data of trade documents is collated with a letter of credit.

To achieve the object in accordance with the present invention, there is provided a document managing system for managing export business including a document receiving section for receiving document data including invoice (I/V) data, packing list data, and shipping instruction (S/I) data required in export business from a client device communicably connected to the document managing system; a document item database for storing a correspondence between the document data and bill of lading (B/L) data, and a B/L creating section for creating B/L data according to the document data and the document item database.

According to the present invention, in the document managing system, the document item database stores items of the B/L data in an XBRL format and the B/L creating section creates the B/L data in the extensible Business Reporting Language XBRL format.

According to the present invention, the document managing system further includes a data format specifying section for receiving a specification of a data format of the document data. The B/L creating section refers, at creation of the B/L data, to the document data according to the data format received by the data format specifying section.

The document managing system further includes a B/L output section for converting the B/L data created from the B/L creating section into data of a predetermined format and outputting the data to a predetermined output device.

According to the present invention, there is provided a document managing system for managing export business including a letter of credit (L/C) storage for storing L/C data, a document storage for storing document data including invoice (I/V) data, packing list data, shipping instruction (S/I) data, and bill of lading (B/L) data; a document data collation database for storing a correspondence between the L/C data and the document data, a negotiation request receiving section for receiving, from a client device communicably connected to the document managing system, negotiation request data for a document bill to which an identifier of the document data is set; and a document collating section for collating, according to the document collation database, the document data stored in the document storage and indicated by an identifier set to the negotiation request data with the L/C data stored in the L/C data storage and transmitting a result of the collation to the client device.

In the document managing system, the L/C data stored in the L/C storage and the document data stored in the document storage are of an XBRL format.

The document managing system further includes an L/C acquisition request receiving section for receiving, from the client device communicably connected to the document managing system, an L/C acquisition request to which an identifier of the L/C data is set and an L/C transmitting section for transmitting the L/C data stored in the L/C storage and indicated by an identifier set to the L/C acquisition request to the client device.

According to the present invention, there is provided a document managing method for use with an information processor of managing documents associated with export business, the information processor including a document item database to store a correspondence between document data including invoice (I/V) data, packing list data, and shipping instruction (S/I) data and bill of lading (B/L) data. The method includes the steps of receiving by the information processor the document data from a client device communicably connected to the information processor and creating by the information processor the B/L data according to the document data and the document item database.

### BRIEF DESCRIPTION OF THE DRAWINGS

FIG. 1 is a block diagram showing a configuration of an information processing system including an embodiment of a document managing system according to the present invention.

FIG. 2 is a block diagram showing a hardware configuration of an information processing system in which a document managing system is installed.

FIG. 3 is a diagram showing a layout of invoice data.

FIG. 4 is a diagram showing a data layout of a packing list.

FIG. 5 is a diagram showing a data layout of a shipping instruction.

FIG. 6 is a diagram showing a data layout of a bill of lading.

FIG. 7 is a diagram showing a data layout of a letter of credit.

FIG. 8 is a diagram showing a data layout of an export bill.

FIG. 9 is a diagram showing a data layout of an exchange contract list.

FIG. 10 is a diagram showing a layout of subscriber data stored in an authentication information database.

FIG. 11 is a diagram showing a login screen displayed on a personal computer (PC) of an exporter.

FIG. 12 is a diagram showing a menu screen displayed on a personal computer of an exporter.

FIG. 13 is a diagram showing a data transmission screen displayed on a personal computer of an exporter.

FIG. 14 is a diagram showing an L/C information download screen displayed on a personal computer of an exporter.

FIG. 15A is a diagram showing an export bill negotiation/exchange contract list inquiry screen displayed on a personal computer of an exporter.

FIG. 15B is a diagram showing an export bill negotiation/exchange contract list display screen displayed on a personal computer of an exporter.

FIGS. 16A, 16B, and 16C are diagrams showing screen images displayed on a display of the information processor when B/L data is created from trade document data in the document managing system.

FIG. 17 is a flowchart showing processing to receive a letter of credit.

FIG. 18 is a flowchart showing processing to create a shipping instruction (S/I).

FIG. 19 is a flowchart showing processing to negotiate a document bill.

FIG. 20 is a flowchart showing in detail processing of collation in the document bill negotiation.

FIG. 21 is a flowchart showing processing to negotiate a letter of credit.

FIG. 22 is a flowchart showing processing to receive negotiation data.

FIG. 23 is a flowchart showing negotiation data inquiry processing.

FIG. 24 is a flowchart showing a conventional flow of processing to receive negotiation data.

### DESCRIPTION OF THE EMBODIMENTS

System Configuration

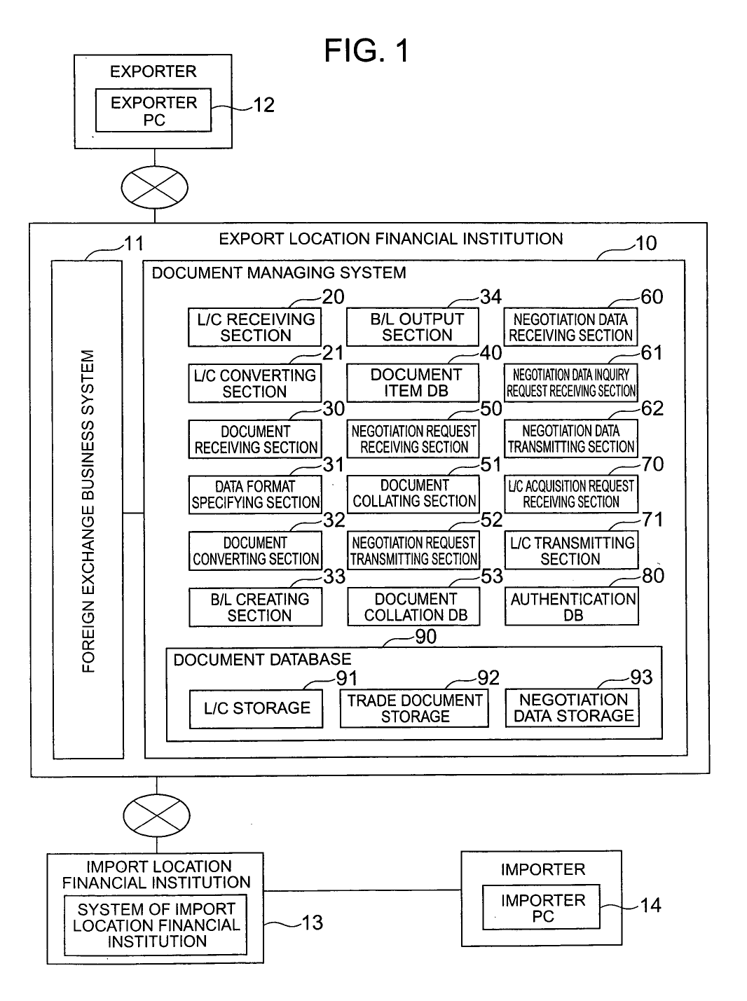

FIG. 1 shows in a block diagram an overall configuration of an information processing system including an embodiment of a document managing system according to the present invention.

An export location financial institution includes a document managing system 10 and a foreign exchange (business) system 11. The system 10 is a system to manage trade documents required for an exporter to export goods. The system 11 is a system which conducts, for example, booking of accounts of foreign exchange transactions and remittance of money to a foreign country.

A personal computer (PC; client device) 12 of an exporter is communicably linked via a network such as the internet with the document managing system 10 and the foreign exchange system 11. An import location financial institution system 13 installed in an import location financial institution is communicably connected via Society for Worldwide Interbank Financial Telecommunication (SWIFT) to the foreign exchange system 11.

The document managing system 10 includes an L/C receiving section 20, an L/C converting section 21, a document receiving section 30, a data format specifying section 31, a document converting section 32, a B/L creating section 33, a B/L output section 34, a document item database 40, a negotiation request receiving section 50, a document collating section 51, a negotiation request transmitting section 52, a document collation database 53, a negotiation data receiving section 60, a negotiation data inquiry request receiving section 61, a negotiation data transmitting section 62, an L/C acquisition request receiving section 70, an L/C transmitting section 71, an authentication database 80, and a document database 90. The database 90 includes an L/C storage 91, a document storage 92, and a negotiation data storage 93.

After a contract is made between an exporter and an importer to trade goods, the importer transmits an L/C opening request to the import location financial institution system 13 using the PC 14 of the importer. When the financial institution opens the L/C, the system 13 sends L/C data indicating the L/C to the foreign exchange system 11 of the export location financial institution. The system 11 sends a message of arrival of the L/C via, for example, e-mail to the PC 12 of the exporter.

The system 11 sends the L/C data to the document managing system 10.

The L/C receiving section 20 of the system receives the L/C data sent from the system 11. The L/C converting section 21 converts the L/C data into data of an XBRL format according to data registered to the document item database 40. The data of the XBRL format is stored in the L/C storage 91.

Having received the notification or advice of L/C arrival, the exporter creates electronic data of trade documents required for the export business. The trade documents includes an invoice (I/V), a packing list, and a shipping instruction (S/I). The exporter sends I/V data, packing list data, and S/I data respectively of the invoice, the packing list, and the shipping instruction to the document managing system 10 using the PC 12. To facilitate an action or a response from the exporter to the system 10, several data formats are used for document data. The data formats are, for example, a DOC format which is a data format of Word (registered trademark) and an XLS format and a Comma Separated Values (CSV) format as data formats of Excel (registered trademark).

The document receiving section 30 of the system 10 receives document data sent from the exporter PC 12. The document converting section 32 converts the document data, by regarding the data as electronic data in a data format specified by the specifying section 31, into data of the XBRL format according to data registered to the document item database 40. The data of the XBRL format is stored in the document storage 92. The B/L creating section 33 creates S/I data, by regarding the document data as electronic data in a data format specified by the specifying section 31, into B/L data of the XBRL format according to data registered to the document item database 40. The created B/L data is stored in the document storage 92. The B/L output section 34 has a function to output the contents of the B/L data created by the B/L creating section 33 to, for example, a display.

As described above, the document database 40 conducts actions or operations registered thereto to convert the L/C data received from the foreign exchange system 11 and the document data received from the exporter PC 12 into data of the XBRL format. The database 40 also includes a correspondence between the data items of the document data from the PC 12 and those of the B/L data.

The negotiation request receiving section 50 receives negotiation request data from the PC 12. The negotiation request data is data to indicate a request for negotiation of a document bill drawn by the exporter. The data includes an identifier set thereto to identify document data associated with the document bill. The document collation database 53 includes a correspondence registered thereto between the data items of the L/C data stored in the L/C storage 91 and those of document data including the B/L data stored in the document storage 92. The document collating section 51 refers, according to an identifier set to the negotiation request data, to the L/C data stored in the L/C storage 91 and the document data including the B/L data stored in the document storage 92. The section 51 collates the L/C data with the document data according to the data registered to the document collation database 53. Only if a result of the collation matches or satisfies a predetermined condition, the negotiation request transmitting section 52 sends the negotiation request data to request negotiation of the document bill to the foreign exchange system 11.

When the negotiation processing of the document bill is executed, the foreign exchange system 11 sends to the document managing system 10 negotiation data including data such as managing data regarding a bill number, a settlement day, a settlement amount, and transfer of B/L ownership.

The negotiation data receiving section 60 of the document managing system 10 receives the negotiation data sent from the foreign exchange system 11. The data is stored in the negotiation data storage 93. The negotiation data inquiry request receiving section 61 receives from the PC 12 an inquiry request for negotiation data stored in the storage 93. The inquiry request includes a bill number of the document bill. The negotiation data transmitting section 62 sends, by referring to negotiation data stored in the storage 93, the negotiation data to the transmission source of the inquiry request.

The L/C acquisition request receiving section 70 receives from the PC 12 an acquisition request for L/C data stored in the L/C storage 91. The acquisition request includes an identifier of the L/C data. If the importer PC 14 is communicably connected to the document managing system 10, the section 70 can also receive an acquisition request for L/C data from the PC 14. The L/C transmitting section 71 obtains L/C data having the identifier from the L/C storage 91 and sends the L/C data to the transmission source of the acquisition request.

The authentication database 80 stores login information such as a user identifier (ID) and a password for the exporter PC 12 to establish connection to the document managing system 10.

Hardware Configuration

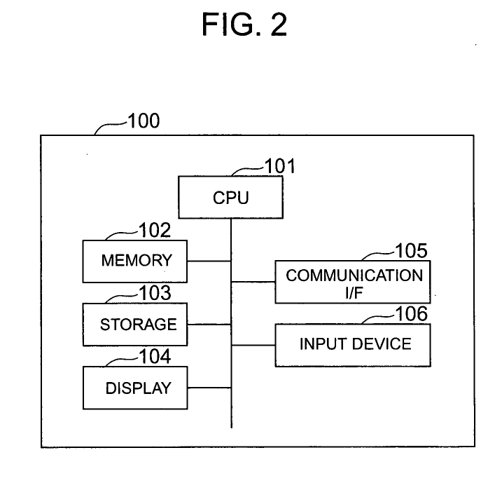

FIG. 2 shows in a block diagram a hardware configuration of an information processing system 100 in which the document managing system is installed. The information processing system or information processor 100 includes a central processing unit (CPU) 101, a memory 102, a storage 103, a display (an output device) 104, a communication interface 105, and an input device 105.

The storage 103 is, for example, a hard disk drive. When programs stored in the storage 103 are sequentially read therefrom to be loaded in the memory 102 and the CPU 101 executes the programs, various functions are achieved.

The communication interface 105 is an interface to communicate data via a network with, for example, the exporter PC 12 and the import location financial institution system 13. The input device 106 is an input device such as a keyboard and/or a mouse.

The sections of the document managing system 10 shown in FIG. 1 are implemented by hardware units of the information processor 100 and programs executed by the CPU 101.

Data Layout

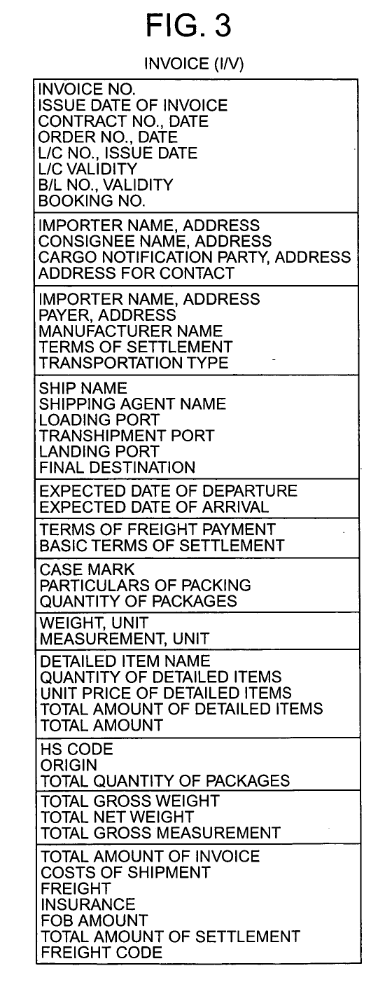

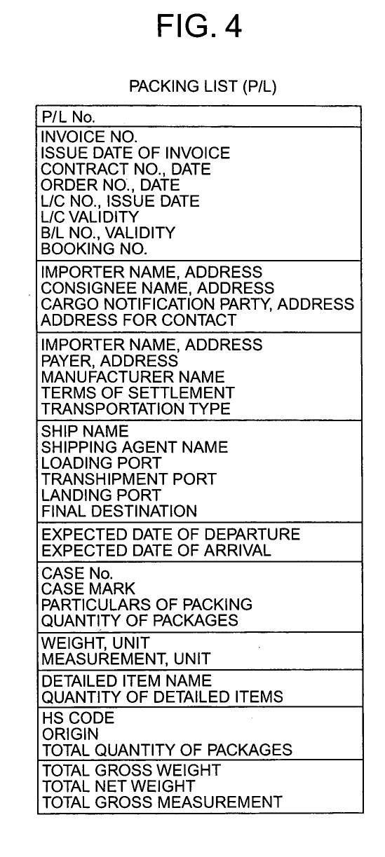

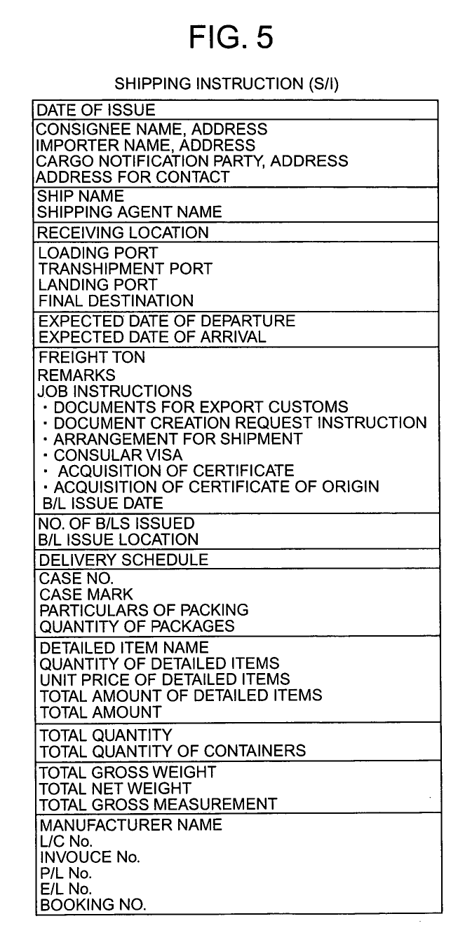

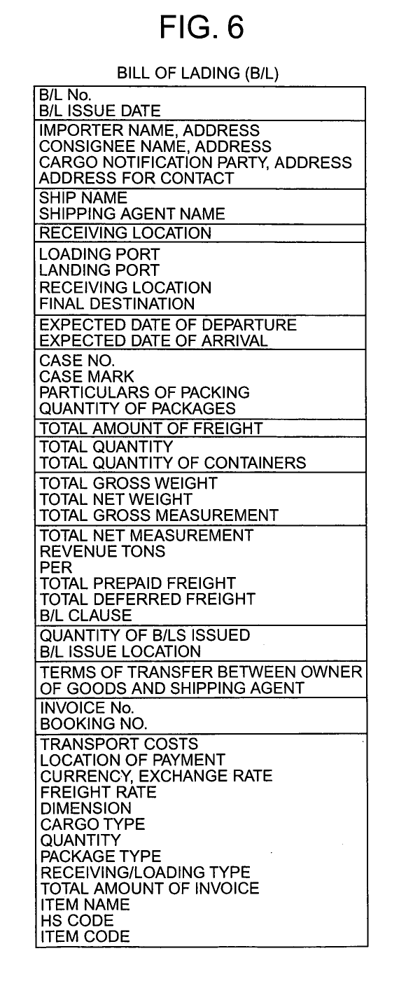

Description will now be given of data layouts of the document data, the L/C data, and the like. FIG. 3 shows a layout of invoice data. The invoice data includes data items such as an invoice number as an identifier of an associated invoice, an L/C number as an identifier of an L/C corresponding to the invoice, and information regarding a quantity of export goods and an amount of money of goods to be exported. FIG. 4 is a diagram showing a data layout of data of a packing list. The data includes, for example, a packing list (P/L) number as an identifier of an associated packing list, an invoice number, and an L/C number. FIG. 5 shows a data layout of a shipping instruction. The data includes data items such as an invoice number, a P/L number, and indication items such as customs clearance and shipment. FIG. 6 is a diagram showing a data layout of a bill of lading (B/L). The data includes, for example, a B/L number as an identifier of an associated bill of lading and various data items which are copied or created from the invoice data, the packing list data, and the shipping instruction data.

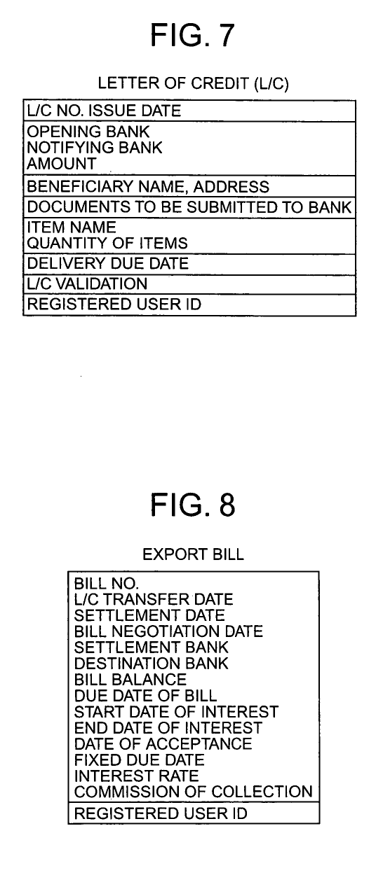

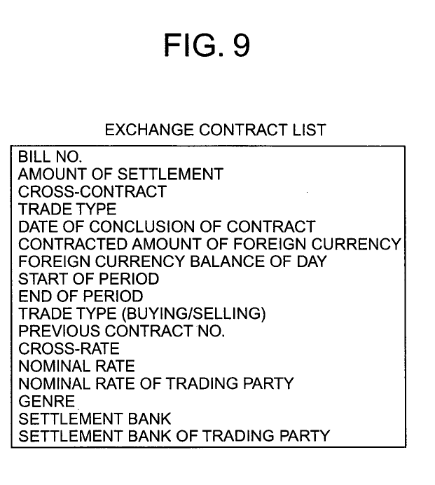

FIG. 7 is a diagram showing a data layout of L/C data. The data includes data items such as an L/C number as an identifier of an associated letter of credit and information of a financial institution having opened an account of the letter of credit. FIG. 8 shows a data layout of an export bill and FIG. 9 is a diagram showing a data layout of exchange contract data.

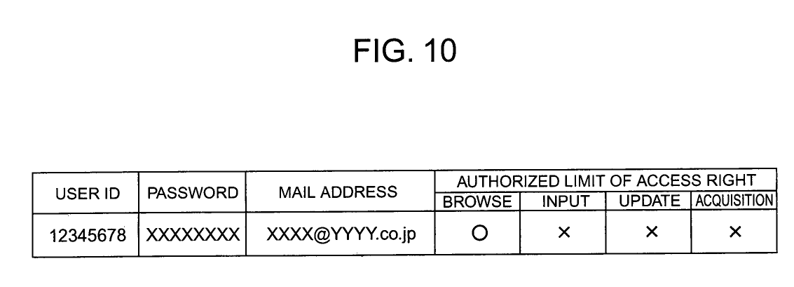

FIG. 10 is a diagram showing a layout of the subscriber data stored in the authentication information database 80. The subscriber data includes data items such as a password, a mail address to make contact with a party concerned, and an authorized limit of access right. The authorized limit indicates, when an attempt is made to access the document managing system 10, whether or not the access is allowed. The authorized limit is determined for each of several types such as browsing, data input, data update, and data acquisition.

Screen Transition

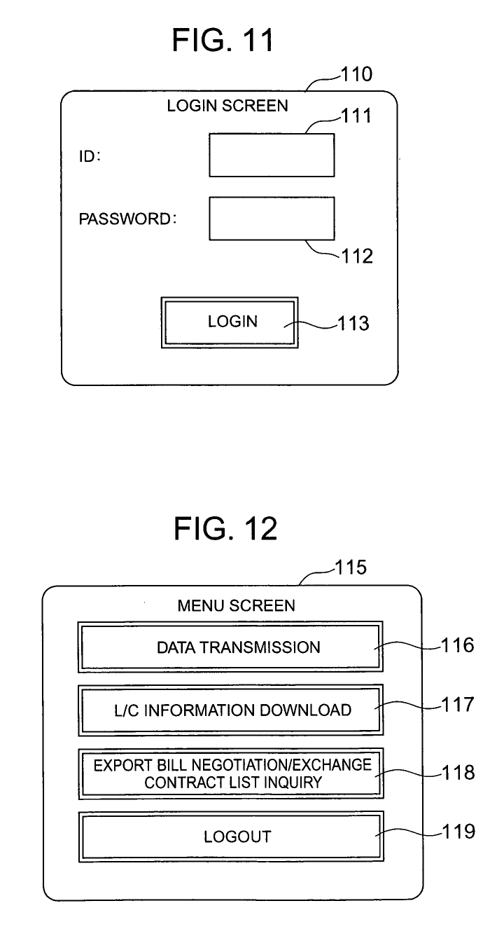

Next, description will be given of screen images displayed in the document managing system. FIG. 11 shows a login screen image 110 displayed when the personal computer (PC) 12 of the exporter is coupled with the system 10. The screen 110 includes an user ID input area 111, a password input area 112, and a login button 113 to instruct execution of the login processing. When the login button 113 is depressed, the user ID and the password as login information items respectively inputted in the areas 111 and 112 are sent to the system 10 to conduct user authentication according to data registered to the authentication database 80.

FIG. 12 shows a menu screen 115 displayed on the exporter PC 12 after the user authentication is finished. The screen 115 includes a data transmission button 116, an L/C information download button 117, and an export bill negotiation/exchange contract list inquiry button 118. When one of the buttons 116 to 118 is depressed, there is displayed a screen to use an associated function supported by the document managing system 10. The menu screen 115 also includes a logout button 119. When the button 119 is depressed, the PC 12 logs out from the system 10 and the menu screen 115 is closed.

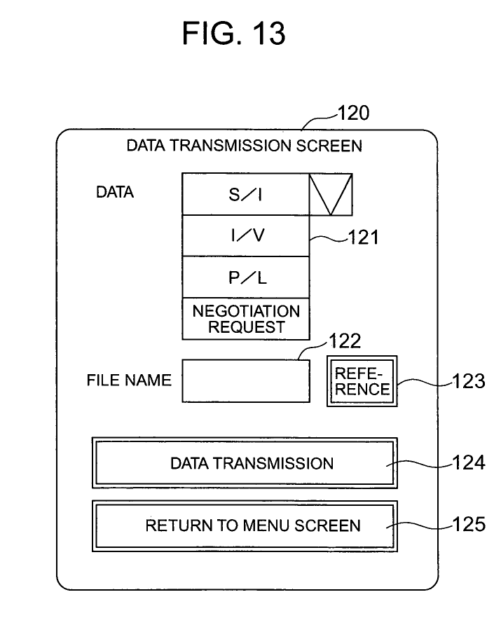

FIG. 13 shows a data transmission screen 120 displayed on the personal computer 12. The screen 120 is displayed when the data transmission button 116 is depressed in the menu screen 115. The screen 120 includes a data selection list 121, a file name input area 122, a file name reference button 123, and a data transmission button 124. When the user inputs a file name of data selected from the data selection list 121 in the input area 122 and depresses the data transmission button 124, the data is sent to the document managing system 10. The file name may also be selected from a list displayed by depressing the reference button 123. The screen 120 also includes a button 125 to return to the menu screen 115. When the button 125 is depressed, the data transmission screen 120 is closed and the menu screen 115 is displayed.

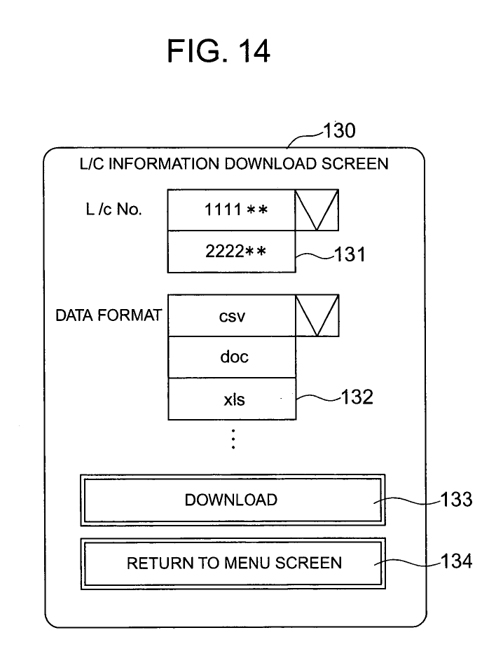

FIG. 14 shows an L/C information download screen 130 displayed on the PC 12 of the exporter. The screen 130 is displayed when the download button 117 is depressed in the menu screen 115. The screen 130 includes an L/C number selection list 131 to select an identifier of a letter of credit, a data format list 132 to select a data format of L/C data to be obtained, and a download button 133. When the button 133 is depressed, L/C data having the L/C number selected from the selection list 131 is converted into data of the data format specified using the data format list 132. The data is sent from the document managing system 10 to the PC 12. The download screen 130 includes a return button 134 to return to the menu screen 115. When the button 134 is depressed, the download screen 130 is closed and the menu screen 115 is displayed.

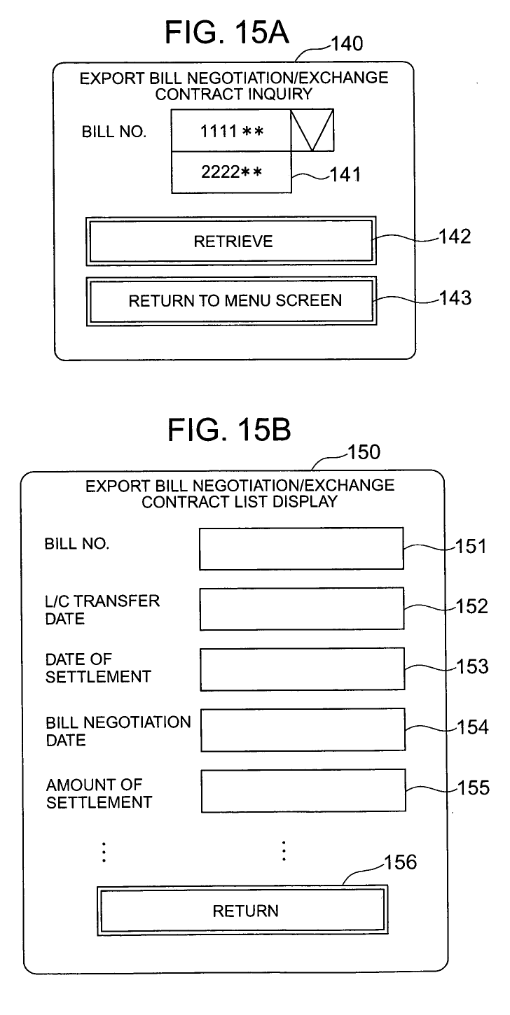

FIG. 15A shows an export bill negotiation/exchange contract list inquiry screen 140 displayed on the exporter PC 12. FIG. 15B shows an export bill negotiation/exchange contract list display screen 150 displayed on the PC 12. The screen 140 of FIG. 15A is displayed when an export bill negotiation/exchange contract list inquiry button 118 is depressed. The screen 140 includes a bill number selection list 141 and a retrieval button 142. When the user selects a bill number using the selection list 141 and depresses the retrieval button 142, information of an export bill associated with the bill number and details of an associated exchange contract are displayed on the screen 150 of FIG. 15B. The screen includes display areas 151 to 155 to display items set to the export bill and the exchange contract list. The screen 150 also includes a return button 156. When the button 156 is depressed, the screen 150 is closed and the screen 140 is displayed. The screen 140 also includes a return button 143. When the button 143 is depressed, the screen 140 is closed and the menu screen 115 is displayed.

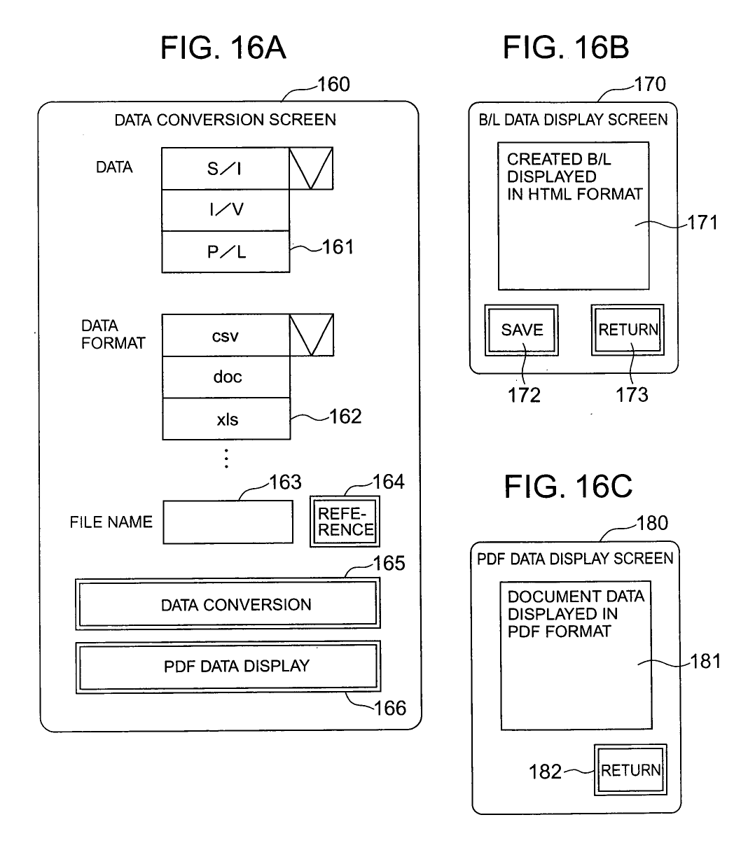

FIGS. 16A to 16C are diagrams showing screens 160, 170, and 180 displayed on a display 104 of the information processor 100 when the B/L data is created in the document managing system 10. The data conversion screen 160 of FIG. 16A includes a data selection list 161, a data format list 162, a file name input area 163, a reference button 164, a data conversion button 165, and Pdf data display button 166. The user selects a type of target data from the list 161, specifies a data format of the target data using the list 162, and inputs a file name of the data to the input area 163. After a data format is specified and a file name is inputted for each of the invoice data, the packing list data, and the shipping instruction data; when the data conversion button 165 is depressed, B/L data is created according to the document data items. In the embodiment, the data format specifying section 31 is implemented using the data format list 162.

The created B/L data is displayed in the HTML format in a display area 171 of the B/L data display screen 170 of FIG. 16B. The screen 170 includes a save button 172 and a return button 173. When the save button 172 is depressed, the created B/L data is stored in the document storage 92 in the XBRL format. When the return button 173 is depressed, the screen 170 is closed and the data conversion screen 160 is displayed.

When a Pdf data display button 166 is depressed in the screen 160, the B/L data stored in the document storage 92 is converted into data of the PDF format to be displayed in a display area 181 of the display screen 180 of FIG. 16C. When a return button 182 is depressed, the screen 180 is closed and the data conversion screen 160 is displayed.

L/C Receiving Processing

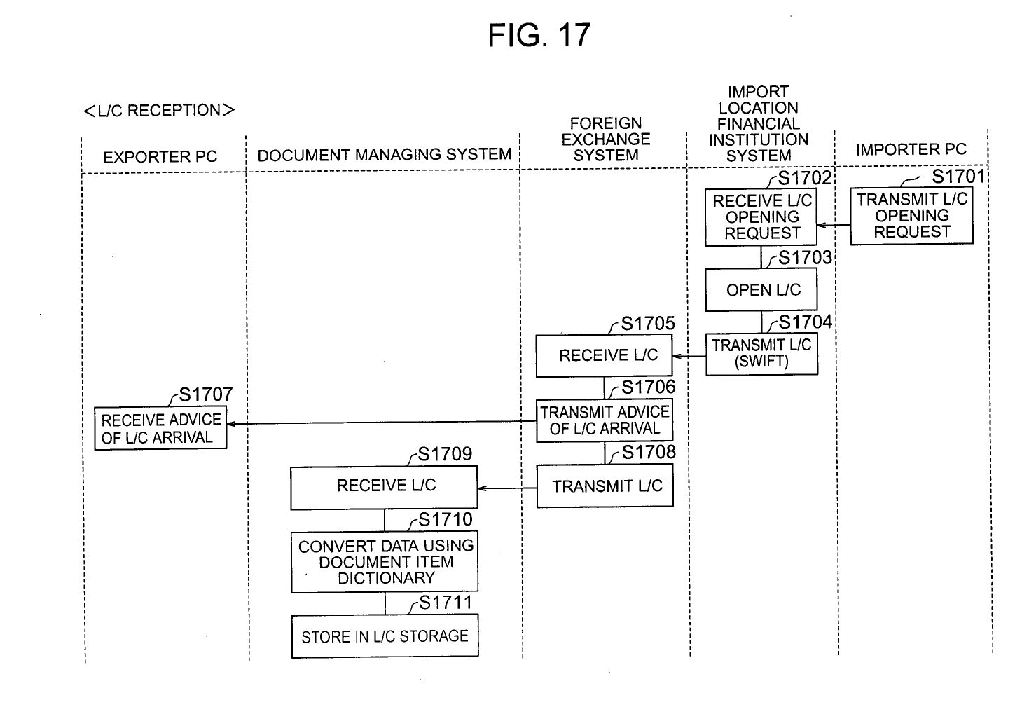

Next, description will be given of various processing executed in the document managing system 10. First, description will be given of processing executed from when a letter of credit is opened to when the export location financial institution and the exporter receive L/C data. FIG. 17 shows processing to receive L/C data in a flowchart. First, the exporter PC 14 sends open request data for a letter of credit to the import location financial institution system 13 (S1701). Having received the open request data (S1702), the system 13 opens a letter of credit (S1703). L/D data of the letter of credit is sent from the system 13 via SWIFT to the foreign exchange system 11 of the export location financial institution (S1704).

When the L/C data is received (S1705), the system 11 sends an arrival notification or advice of the letter of credit, for example, by e-mail to the exporter PC 12 (S1706). When the PC 12 receives the notification (S1706), the exporter can confirm that the letter of credit prepared at the import location is arrived.

The system 11 sends the L/C data to the document managing system 10 (S1708). The L/C receiving section 20 of the system 10 receives the L/C data (S1709). The L/C converting section 21 converts the L/C data into data of the XBRL format according to the document item database 40 (S1710) and stores the data in the L/C storage 91 (S1711).

B/L Creating Processing

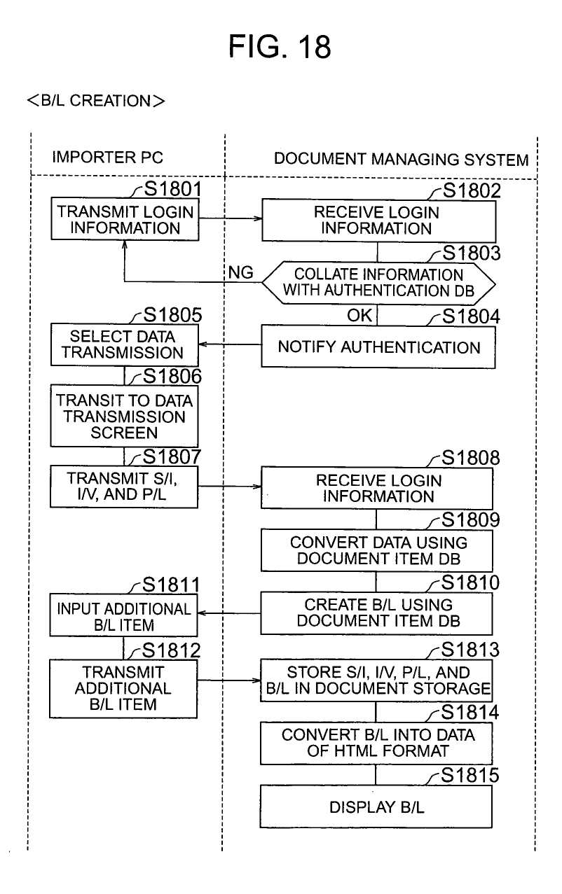

Description will next be given of processing to create B/L data using I/V data, packing list data, and S/I data in the document managing system 10. FIG. 18 shows processing to create a shipping instruction (S/I) in a flowchart. First, the user inputs an ID and a password in the login screen 110 of the exporter PC 12 and depresses the login button 113 (S1801). Having received login information (S1802), the system 10 collates the login information with associated data in the authentication database 80 (S1803).

If the login information does not match with information of the associated data registered to the database 80 (NG in S1803), the system 10 notifies to the PC 12 that the login information is not acceptable. After the notification is received, the PC 12 conducts again the login operation (S1801).

If the login information matches with information of the associated data registered to the database 80 (OK in S1803), the system 10 notifies to the PC 12 that the login has been normally conducted (S1804). After the notification is received, if the user operates the data transmission button 116 in the menu screen 115 of the PC 12 (S1805), control goes to the data transmission screen 120 (S1806). The user selects data from the data selection list 121 of the PC 12, inputs a file name in the file name input area 122, and makes the PC 12 send the I/V data, the packing list data, and the S/I data to the document managing system (S1807).

The document receiving section 30 of the system 10 receives the I/V data, the packing list data, and the S/I data (S1808). When the user specifies data formats and file names respectively of the document data items and depresses the data conversion button 165 in the data conversion screen 160, the document converting section 32 refers to the document data according to the data format specified in the data format specifying section 31 (data format list 162) to convert the document data into data of the XBRL format according to associated data in the document item database 40 (S1809). The converting section 32 refers to the document data according to the data format specified in the data format specifying section 31 to create B/L data of the XBRL format using the document data according the document item database 40 (S1810). To add information to the B/L data created using the document data, the user inputs additional items unique to the B/L data from the PC 12 (SI811). The PC 12 sends data of the additional items to the document managing system 10 (S1812). The document converting section 32 stores the I/V data, the packing list data, the S/I data, and the B/L data of the XBRL format in the document storage 92 (S1813).

The B/L output section 32 converts the B/L data created by the document converting section 32 into data of the HTML format (S1814) to display the data in the B/L data display screen 170 (S1815).

Negotiation Request Processing

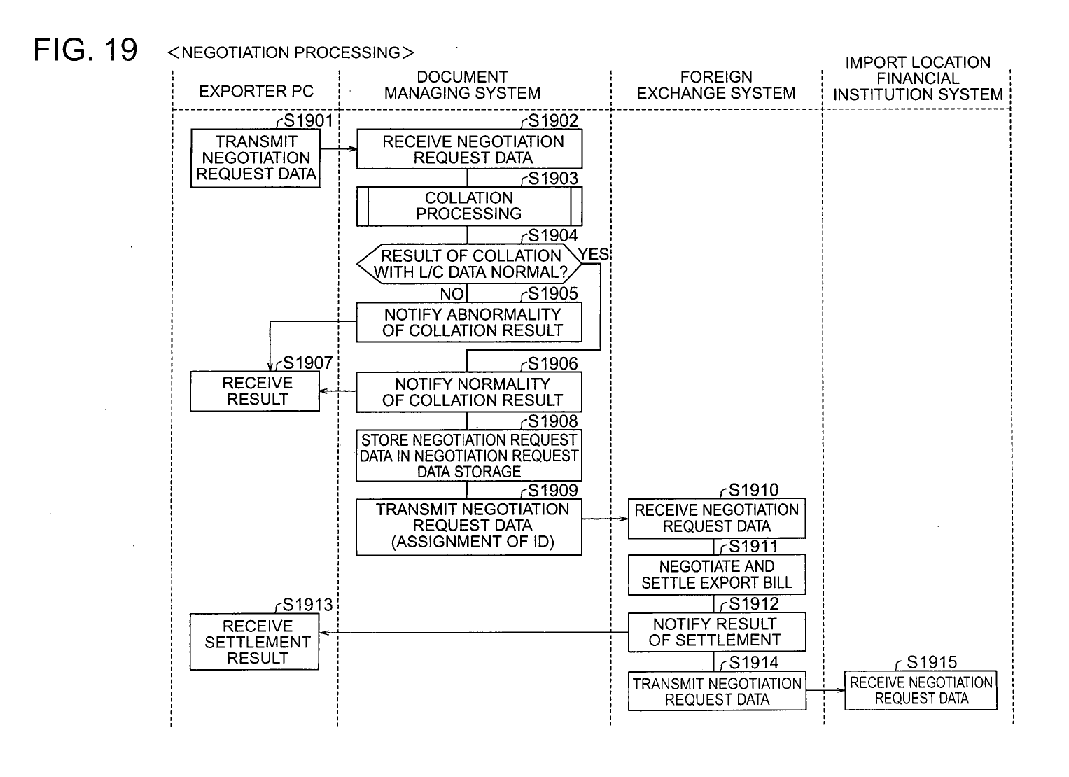

Description will next be given of processing for the export location financial institution to negotiate the document bill drawn by the exporter. FIG. 19 is a flowchart showing processing to negotiate a document bill. The user transmits data to request negotiation of a document bill from the PC 12 to the document managing system 10 (S1901). The negotiation request data is transmitted as below. The user selects “negotiation request” in the data selection list 121 of the data transmission screen 120, inputs a file name of the negotiation request data to the input area 122, and then depresses the data transmission button 124. The negotiation request data includes an identifier set thereto to identify document data such as I/V data, packing list data, S/I data, and B/L data. The identifier is, for example, an L/C number and an invoice number.

The negotiation request receiving section 50 of the system 10 receives the negotiation request data sent from the PC 12 (S1902). According to the data, the document collating section 51 collates the document data items including the I/V data, the packing list data, the S/I data, and the B/L data with those of an associated letter of credit (S1903) to determine whether or not the document data items has been correctly created. If a result of the collation between the document data and the L/C data is not normal (no in S1904), the section 51 notifies abnormality of the collation result to the PC 12 (S1905). If the result of the collation between the document data and the L/C data is normal (yes in S1904), the section 51 notifies normality of the collation result to the PC 12 (S1906). The PC 12 receives the collation result sent from the system 10 (S1907). The section 51 stores the negotiation request data for which the collation result is normal in the negotiation data storage 93 (S1908). The exporter visits the export location financial institution, the institution negotiates the document bill and pays the amount of money for the export to the exporter. Next, description will be given of processing to automatically achieve settlement.

The negotiation request transmitting section 52 adds an identifier to the negotiation request data for identification thereof and sends the data to the foreign exchange system 11 (S1909). When the data is received (S1910), the system 11 executes processing of negotiation and settlement for the document bill (export bill; S1911) and notifies a result of settlement, for example, by e-mail to the exporter PC 12 (S1912). The PC 12 receives the settlement result sent from the system 12 (S1913). To collect the amount of money paid to the exporter, the system 11 sends collection request data for the collection of the document bill to the import location financial institution system 13 to request the collection of the document bill (S1914). The system 13 receives the collection request data sent from the system 11 (S1915). As described above, the message received by the exporter may be a result of the collection request or information of completion of the settlement. According to the received message, the exporter can recognize the present status.

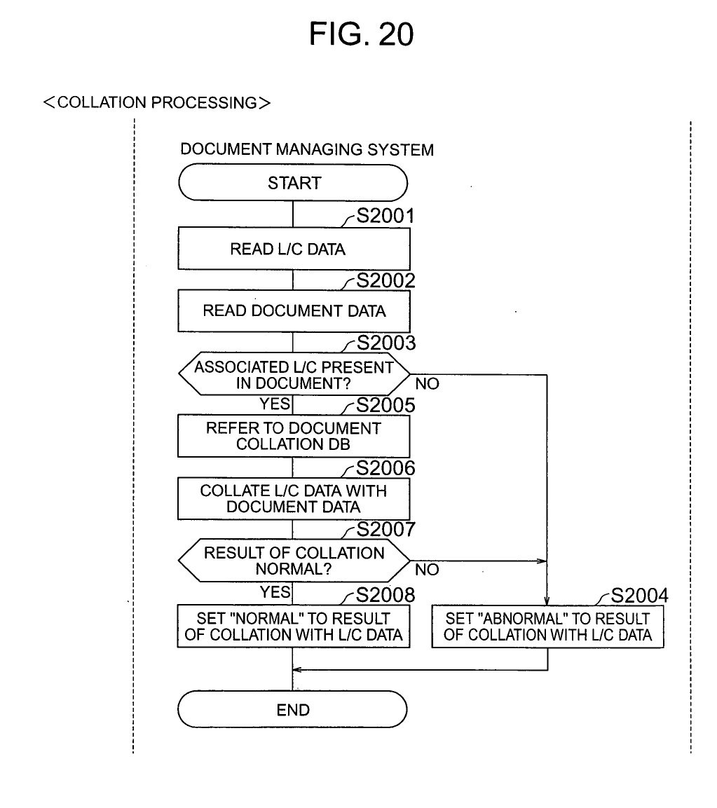

FIG. 20 is a flowchart showing in detail the collation processing (S1903). The document collating section 51 read L/C data from the L/C storage 91 (S2001). According to the identifier of the document data set to the negotiation request data, the section 51 reads document data (I/V data, packing list data, S/I data, and B/L data) from the document storage 92. The document collating section 51 makes a check to confirm whether or not associated L/C data is present in the obtained document data (S2003). The correspondence between the document data and the L/C data is confirmed as below. For the I/V data, the packing list data, and S/I data, the correspondence is confirmed according to whether or not an equal L/C number has been set to the data items. For the B/L data, a check is made to confirm whether or not an equal B/L number has been set to the B/L data and the I/V data.

If the associated L/C data is absent from the document data (no in S2003), the document collating section 51 sets information of abnormality to the result of collation between the document data and the L/C data (S2004).

If the associated L/C data is present in the document data (yes in S2003), the section 51 refers to the document collation database to which collation rules between the document data and the L/C data are registered (S2005). According to the rules, a check is made to determine whether or not the L/C issue date, the L/C validity, the item name, and the quantity of items set to each of the L/C data and the document data are respectively equal in the L/C data and the document data. The rules may also include, in addition to a rule using simple collation between items, a rule to check, for example, specification of the quantity of forms of the documents and specification of the import location bank indicated by the document data.

According to the collation rules registered to the database 53, the section 51 collates the L/C data with the document data (S2006). If the collation is successfully finished for all collation rules (yes in S2007), the section 51 sets information of normality to the result of the collation between the L/C data and the document data (S2008). If the collation is not successfully finished for any one of the collation rules (no in S2007), the section 51 sets information of abnormality to the result of the collation between the L/C data and the document data (S2004).

L/C Acquisition Processing

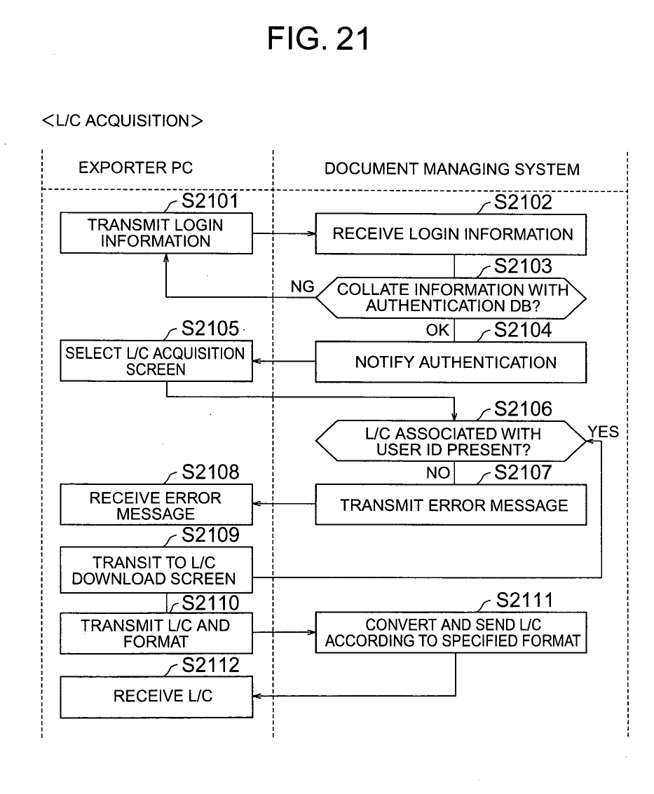

Next, description will be given of processing to acquire L/C data. FIG. 21 is a flowchart showing the L/C acquisition processing. First, the exporter inputs an ID and a password to the login screen 110 of the PC 12 and then depresses the button 113. The PC 12 sends the ID and the password inputted by the exporter to the document managing system 10 (S2101). The system 10 receives login information (S2102) and collates the information with data in the authentication database 80 (S2103).

If the login information does not match with the data registered to the database 80 (NG in S2103), the system 10 notifies to the PC 12 the state that the login information is not acceptable, and then the exporter conducts the login again from the PC 12 (S2101).

If the login information matches with the data registered to the database 80 (OK in S2103), the system 10 notifies to the PC 12 the state that the login has been normally finished (S2104). After the notification is received, when the user selects the L/C information download button 117 in the menu screen 115 of the PC 12 (S2105), the L/C transmitting section 71 makes a check to determine whether or not associated L/C data corresponding to the user ID is stored in the L/C storage 91 (S2106).

The L/C data is obtained according to a result of matching between the registered user ID set to the L/C data shown in FIG. 7 and the user ID inputted at authentication. When the L/C data is sent from the import location financial institution, an associated user ID is automatically added thereto using the beneficiary name and address. In the subscriber data shown in FIG. 10, an authorized limit of access right is set to each user ID. The L/C data is obtained through a control operation according to the authorized limit of access right.

If the L/C data corresponding to the user ID is absent from the L/C storage 91 (no in S2106), the L/C transmitting section 71 sends an error message to the PC 12 of the exporter to indicate that the L/C data is absent (S2107). The PC 12 receives the error message from the document managing system 10 (S2108).

If the L/C data corresponding to the user ID is present in the L/C storage 91 (yes in S2106), the L/C transmitting section 71 sends to the PC 12 the L/C information download screen 130 in which the L/C number of the L/C data is set to the selection list 131. This makes the PC 12 display the screen 130 (S2109). The exporter then selects one of the L/C numbers from the selection list 131 and specifies, using the data format list 132, a data format of the L/C data to be obtained. The PC 12 sends to the system 10 the L/C number selected from the selection list 131 and the data format specified using the data format list 132 (S2110). The L/C acquisition request receiving section 70 receives the L/C number and the data format sent from the PC 12. The L/C transmitting section 71 converts the L/C data of the L/C number into data of the specified data format and sends the data to the PC 12 (S2111). The PC 12 receives the L/C data sent from the system (S2112).

Negotiation Data Receiving Processing

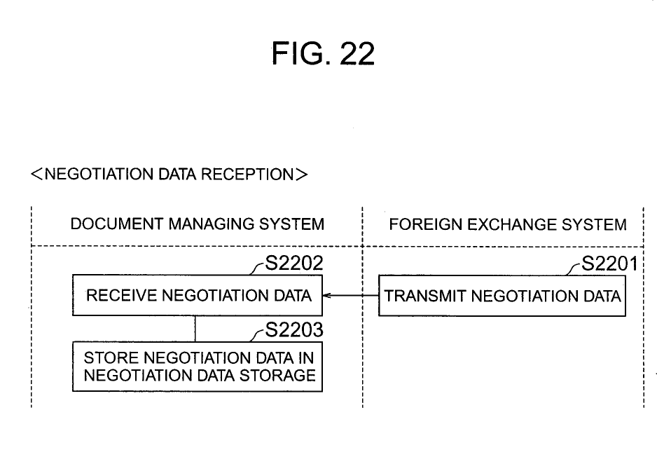

Next, description will be given of processing to receive negotiation data of a document bill (export bill). FIG. 22 is a flowchart showing negotiation data receiving processing. When the negotiation settlement processing is completed, the foreign exchange system 11 sends negotiation data to the document managing system 10 (S2201). The data includes the export bill data shown in FIG. 8 and the data of the exchange contract list shown in FIG. 9.

The negotiation data receiving section 60 of the system 10 receives the negotiation data sent from the system 11 (S2202) and stores the data in the negotiation data storage 93 (S2203).

Negotiation Data Inquiry Processing

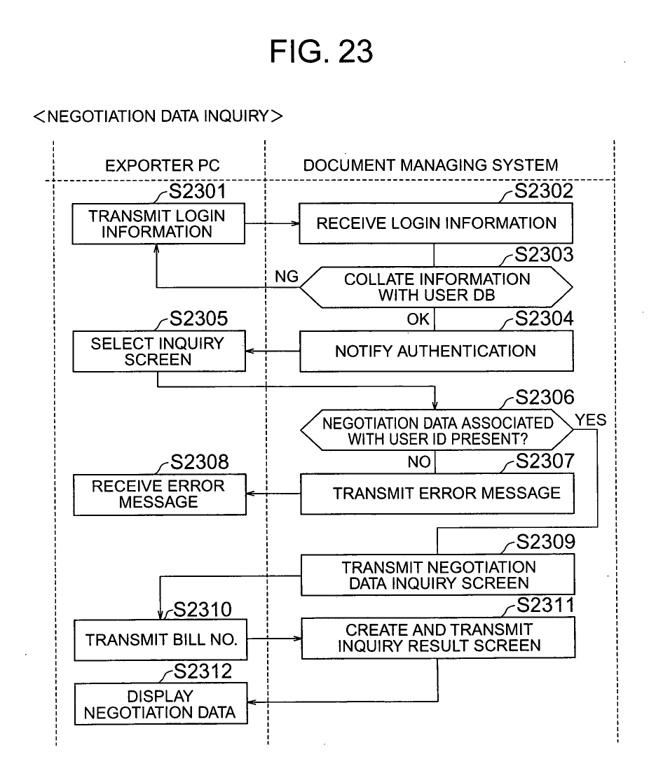

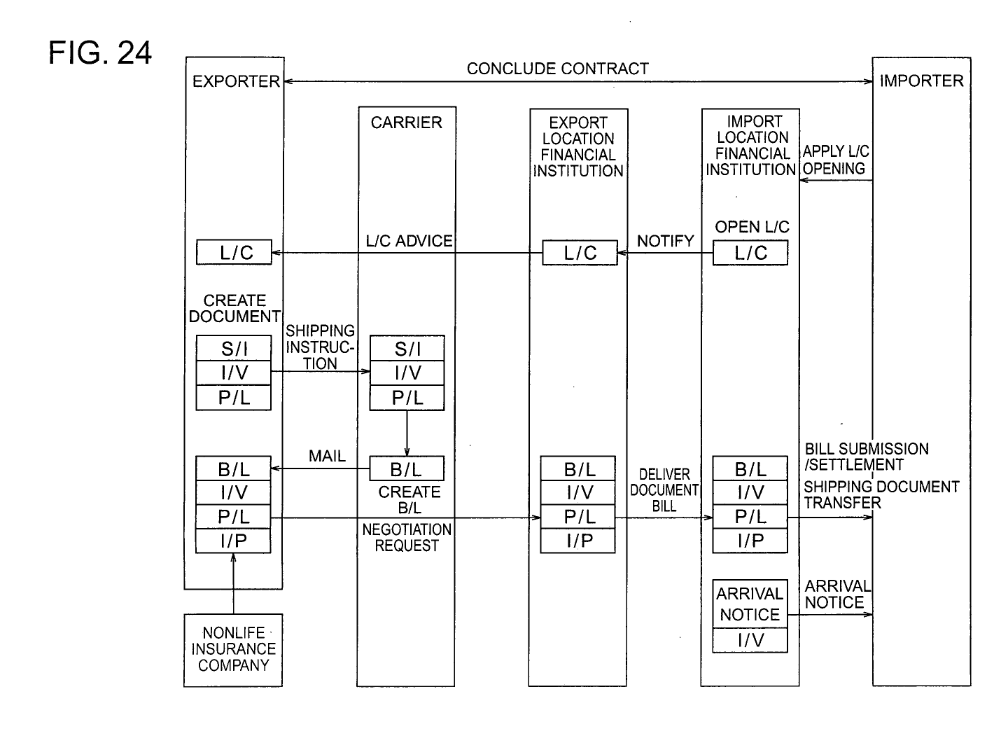

Description will now be given of processing to inquire a negotiation status of a document bill (export bill) and the contents of the exchange contract list. FIG. 23 is a flowchart showing negotiation data inquiry processing. The exporter inputs an ID and a password in the login screen 110 of the PC 12 and depresses the button 113. The PC 12 sends the ID and the password inputted by the exporter to the document managing system 10 (S2301). The system 10 receives login information (S2302) and collates the information with data in the authentication database 80 (S2303).

If the login information does not match with the data of the database 80 (NG in S2303), the system 10 notifies to the PC 12 a state that the login information is not acceptable. Having received the notification, the exporter conducts the login again from the PC 12 (S2301).

If the login information matches with the data of the database 80 (OK in S2303), the system 10 notifies normal termination of the login to the PC 12 (S2304). After the notification is received, when the exporter selects the export bill negotiation/exchange contract list inquiry button 118 in the menu screen 115 of the PC 12 (S2305), the negotiation data transmitting section 62 makes a check to confirm whether or not negotiation data associated with the user ID is in the negotiation data storage 93 (S2306).

The negotiation data is obtained according to a result of matching between the registered user ID set to the export bill data shown in FIG. 8 and the user ID inputted at authentication. When the export bill data is sent from the import location financial institution, an associated user ID is automatically added thereto. In the operation to obtain negotiation data, a control operation is conducted according to the authorized limit of access right set in the subscriber data shown in FIG. 10.

If the negotiation data corresponding to the user ID is absent from the storage 93 (no in S2306), the negotiation data transmitting section 62 sends an error message to the PC 12 to indicate that the negotiation data is absent (S2307). The PC 12 receives the error message from the system 10 (S2308).

If the negotiation data corresponding to the user ID is present in the storage 93 (yes in S2306), the section 62 sends the associated negotiation data (export bill data) to the PC 12. Resultantly, the PC 12 displays the export bill negotiation/exchange contract list inquiry screen 140 in which a bill number of the negotiation data is set to the selection list 141 (S2309). The exporter selects one of the bill numbers from the selection list 141 and depresses the retrieve button 142 of the PC 12. The PC 12 sends the bill number selected from the list 141 to the system 10 (S2310). The negotiation data inquiry request receiving section 61 receives the bill number sent from the PC 12. The negotiation data transmitting section 62 sends to the PC 12 the export bill data and the exchange contract list data to which the bill number is set (S2311). The PC 12 displays the export bill negotiation/exchange contract list display screen 15 to which data items of the negotiation data are set (S2312).

Description has been given of various processing executed in the document managing system 10. According to the embodiment of the document managing system 10, B/L data can be created using the document data such as I/V data, packing list data, and S/I data sent from the PC 12 of the exporter. Therefore, the job for the carrier to manually create the bill of lading is unnecessary and hence the amount of jobs to be conducted in the export business can be reduced.

In the embodiment, the invoice data, the packing list data, the shipping instruction data, and the bill of lading data are recorded in an internationally standardized language, i.e., in the XBRL format. Therefore, the data can be efficiently communicated with external systems installed in, for example, an office of an exporter, an import location financial institution, and an office of an importer.

Moreover, in the embodiment, it is only necessary that the exporter creates the invoice data, the packing list data, the shipping instruction data in one of the data formats including several data formats such as the DOC, XLS, and CSV formats and sends the data to the document managing system 10. Therefore, at transmission of the document data to the system 10 according to the embodiment, it is not required for the exporter to develop programs to create document data in his or her own format. That is, the exporter can readily cope with the document managing system 10.

In the embodiment, the created B/L data is stored in the XBRL format and hence can be readily outputted in, for example, the HTML format and the PDF format. Therefore, whether or not the B/L data has been correctly created can be confirmed. At the same time, the data can be outputted and/or displayed in a format desired by a party of the output destination. By printing the displayed data on a predetermined form, the data items of the created B/L data can be presented or submitted to, for example, the exporter.

Furthermore, in the embodiment, when the export location financial institution negotiates a document bill from the exporter, data items set to the document data are collated with those set to an associated L/C data according to predetermined rules to thereby confirm whether or not the document data matches with the data items described on the associated letter of credit. Resultantly, when the export location financial institution negotiates the document bill, it is not required to visually collate many data items of the document data with those of the letter of credit. Therefore, the check job for the negotiation of the document bill can be efficiently conducted.

In the embodiment, the L/C data is stored also in the XBRL format. Therefore, the data can be converted into data of various data formats and hence the data can be efficiently communicated with external systems installed in, for example, an office of an exporter, an import location financial institution, and an office of an importer. In the embodiment, the exporter can obtain L/C data by sending an L/C data acquisition request from the PC 12 to the document system 10. Since the L/C data is saved in the XBRL format, the data can be downloaded in a data format desired by the exporter, for example, in the CSV format. By sending a negotiation data inquiry request from the PC 12 to the document system 10, the exporter can readily refer to the negotiation status of a document bill and data items of the exchange contract list.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention. The present invention is intended to cover also equivalent arrangements included within the spirit and scope of the claims.

1. A document managing system for managing export business, comprising:
a document receiving section for receiving document data including invoice (I/V) data, packing list data, and shipping instruction (S/I) data required in export business from a client device communicably connected to the document managing system;
a document item database for storing a correspondence between the document data and bill of lading (B/L) data; and
a B/L creating section for creating B/L data according to the document data and the document item database.

2. A document managing system according to claim 1, wherein:
the document item database stores items of the B/L data in an XBRL format; and
the B/L creating section creates the B/L data in the XBRL format.

3. A document managing system according to claim 1, further comprising a data format specifying section for receiving a specification of a data format of the document data, wherein
the B/L creating section refers, at creation of the B/L data, to the document data according to the data format received by the data format specifying section.

4. A document managing system according to claim 1, further comprising a B/L output section for converting the B/L data created from the B/L creating section into data of a predetermined format and outputting the data to a predetermined output device.

5. A document managing system for managing export business, comprising:
a letter of credit (L/C) storage for storing L/C data;
a document storage for storing document data including invoice (I/V) data, packing list data, shipping instruction (S/I) data, and bill of lading (B/L) data;
a document data collation database for storing a correspondence between the L/C data and the document data;
a negotiation request receiving section for receiving, from a client device communicably connected to the document managing system, negotiation request data for a document bill to which an identifier of the document data is set; and
a document collating section for collating, according to the document collation database, the document data stored in the document storage and indicated by an identifier set to the negotiation request data with the L/C data stored in the L/C data storage and transmitting a result of the collation to the client device.

6. A document managing system for managing export business according to claim 5, wherein the L/C data stored in the L/C storage and the document data stored in the document storage are of an XBRL format.

7. A document managing system for managing export business according to claim 5, further comprising:
an L/C acquisition request receiving section for receiving, from the client device communicably connected to the document managing system, an L/C acquisition request to which an identifier of the L/C data is set; and
an L/C transmitting section for transmitting the L/C data stored in the L/C storage and indicated by an identifier set to the L/C acquisition request to the client device.

8. A document managing method for use with an information processor of managing documents associated with export business, the information processor including a document item database to store a correspondence between document data including invoice (I/V) data, packing list data, and shipping instruction (S/I) data and bill of lading (B/L) data, the method comprising the steps of:
receiving by the information processor the document data from a client device communicably connected to the information processor; and
creating by the information processor the B/L data according to the document data and the document item database.

9. A document managing method for use with an information processor of managing documents associated with export business, the information processor including a letter of credit (L/C) storage for storing L/C data, a document data storage for storing invoice (I/V) data, packing list data, shipping instruction (S/I) data, and bill of lading (B/L) data; and a document collation database for storing a correspondence between the L/C data and the document data, the method comprising the steps of:
receiving by the information processor, from a client device communicably connected to the information processor, negotiation request data for a document bill to which an identifier of the document data is set; and
collating by the information processor, according to the document collation database, the document data stored in the document storage and indicated by an identifier set to the negotiation request data with the L/C data stored in the L/C data storage and transmitting a result of the collation to the client device.
